(19) United States
(12) Patent Application Publication
(10) Pub. No.: US 2022/0313536 A1
(43) Pub. Date: Oct. 6, 2022

(54) PHYSICAL THERAPY TREATMENT DEVICE

(71) Applicant: Anthony Cooper, Katy, TX (US)

(72) Inventor: Anthony Cooper, Katy, TX (US)

(21) Appl. No.: 17/519,692

(22) Filed: Nov. 5, 2021

Related U.S. Application Data
(60) Provisional application No. 63/169,483, filed on Apr. 1, 2021.

(51) Int. Cl. A61H 7/00

(52) U.S. Cl. CPC A61H 7/005; A61H 2201/0107; A61H 2201/0153; A61H 2201/5025; A61H 2201/1207; A61H 2201/5015; A61H 2201/1654; A61H 2201/0161; A61H 2201/105

(57) ABSTRACT

The present invention relates generally to the field of massage or therapy devices. The device has a generally u-shaped housing that contains an internal motor and hinge-attached frame arms which connect to hinge-attached handles. The rear surface of the device includes a massage head that can be activated via a plurality of buttons located on the top surface of the housing or the handles. Further, the device can easily fold for storage, handling or transport purposes. During use, the device can be placed around the back or portion of the body of a user in an unfolded and locked state such that a user can massage otherwise hard to reach areas.

### CROSS-REFERENCE TO RELATED APPLICATION

The present application claims priority to, and the benefit of, U.S. Provisional Application No. 63/169,483, which was filed on Apr. 1, 2021 and is incorporated herein by reference in its entirety.

### FIELD OF THE INVENTION

The present invention relates generally to the field of personal comfort accessories. More specifically, the present invention relates to a back-massaging device. The device is comprised of a generally u-shaped housing that contains an internal motor and a hinge-attached frame arms which connect to first and second hinge-attached handles. The rear surface of the device has a massage head that can be activated via a plurality of buttons located on the top surface of the housing or the handles. Further, the device can easily fold for storage or transport purposes. During use, the device can be placed around the back of an individual user in an unfolded and locked state such that individuals can massage otherwise hard-to-reach areas of their back in a manner that requires little flexibility or dexterity. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

Massage and other personal comfort devices such as massage wands or guns are known in the art and are used by many individuals to massage various body parts after physical activity such as exercising, playing sports, lifting weights, etc. Further, existing massage guns or wands known in the art typically have a stem or handle that can be gripped or held by a user in order to position the massage head of the device on the desired body part to be massaged or treated. However, the stem or handle of existing massage devices are normally short in length and require some stretching in order to reach all areas of the back portion of an individual, such that a user cannot physically reach certain areas of his or her back while holding the handle. Further, even if the handle of existing massage devices were longer, a user would still require extreme shoulder and arm flexibility to massage specific hard-to-reach areas of the back. Understandably, this level of flexibility or dexterity is not possessed by most individuals, if any individuals due to the anatomy of the human body or due to other situations such as age or physical condition.

Therefore, there exists a long-felt need in the art for an improved massaging or physical therapy treatment device. There also exists a long-felt need in the art for a massaging or physical therapy treatment device that allows a user to massage or otherwise treat hard-to-reach areas of the back, torso or other areas. Finally, there exists a long-felt need in the art for a back massaging or treatment device that any user can use to massage or treat the back, torso or other difficult to reach areas, without requiring any significant level of flexibility or dexterity in order to reach and massage the desired back or difficult to reach area.

The subject matter disclosed and claimed herein, in one embodiment thereof, comprises a back, torso or other difficult to reach area massaging device. The device body has a generally U-shaped housing or frame which receives two hinge-attached frame arms. Each frame arm has a foldable handle that can be stored or concealed within each arm when not in use. Further, both frame arms can also be concealed or folded when not in use, to allow the device to be easily transported and stored. In addition, the rear surface of the device includes a massage head that is powered by a motor contained within the housing. Accordingly, a user can unfold the device, place the device around the back or other area of the body, and massage areas of the back or body easily and without any significant level of flexibility or dexterity due to the shape and configuration of the device.

In this manner, the back massaging or physical therapy treatment device of the present invention accomplishes all of the forgoing objectives and provides a massaging device that can comfortably be used to massage the back or other area of a user. Further, the back massaging or physical therapy treatment device does not require any significant level of flexibility or dexterity to allow a user to massage hard-to-reach areas of the body. As a result, the device overcomes the deficiencies of other known massage devices in the art that otherwise do not allow a user to massage hard-to-reach areas due to a lack of flexibility or dexterity and/or handle length.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a massaging or physical therapy device. The device has a generally U-shaped housing or frame that includes a pair of hinge-attached foldable frame arms or extensions, a pair of foldable handles attached to each of the arms or extensions, a motor and a massage or treatment head. The motor of the device is stored within the housing or frame and can be powered via a disposable or rechargeable battery. The motor further attaches to a shaft that receives a fixedly attached or removable massage or treatment head. In differing embodiments of the device, the massage head may have any firm or semi-firm material and may be shaped in a plurality of massage or treatment specific shapes.

The housing or frame may also have a pair of hingedly-attached, foldable frame arms which extend upwardly from the frame so as to be easily grasped by the hands. Each frame or support arm also has a hinge-attached handle. Accordingly, both the frame or support arms and handles can be folded for transport or storage purposes. Further, the handle (or top surface of the housing or frame) may have a power button and intensity button that allows a user to control the power of the motor and intensity of the massage or treatment head. Accordingly, to use the device an individual first unfolds the frame arms and handles and locks the hinges of each into place. Then, the motor and massage head can be activated via the on/off, power and intensity level buttons. Next, the unfolded device can be flipped one-hundred and eighty degrees around the back of the user or positioned to massage or treat the desired part of the body. As such, a user can then move his or her arms or shoulders to allow the massage or treatment device to reach and massage differing areas of the back or other portions of the body.

Accordingly, the back massaging device of the present invention is particularly advantageous as it allows a user to massage hard-to-reach areas such as their back in an easier manner than existing massage guns, wands or other devices. Further, use of this invention requires little flexibility or dexterity, which would otherwise be required to attempt to massage the same hard-to-reach areas of the body with any existing massage device known in the art. Further, unlike existing massage devices, the back or body massaging device can be folded into a much smaller compact shape for storage, ease of handling and transport purposes.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a massaging or therapy providing device of the present invention in an unfolded position in accordance with the disclosed architecture;

FIG. 2 illustrates an enhanced perspective view of one potential embodiment of the rear surface area of the massaging or therapy providing device of the present invention in an unfolded position in accordance with the disclosed architecture;

FIG. 3 illustrates a perspective view of one potential embodiment of a massaging or therapy providing device of the present invention in a folded position in accordance with the disclosed architecture;

FIG. 4 illustrates a perspective view of one potential embodiment of the massaging or therapy providing device of the present invention in an unfolded position and being used by a user to massage his or her back in accordance with the disclosed architecture;

FIG. 5 illustrates a perspective view of various attachments that may be used as the massaging aid or therapy providing device of the present invention in accordance with the disclosed architecture; and

FIG. 6 illustrates one potential embodiment of a kit for providing the massage or therapy device of the present invention in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved massaging or therapy providing device. There also exists a long-felt need in the art for a massaging or therapy providing device that allows a user to reach and massage otherwise hard-to-reach areas of the body such as the back. Finally, there exists a long-felt need in the art for a back massaging or therapy providing device that can be used to massage hard-to-reach areas of a user's body without requiring any significant level of flexibility or dexterity in order to position or reach the desired body area, that would otherwise be required when using existing massage devices known in the art.

The present invention, in one exemplary embodiment, is comprised of a back massaging or therapy providing device. The device includes a plurality of components, and in one example the preferred components of the device include: a generally U-shaped housing that has a pair of hinge-attached foldable frame arms, a pair of foldable handles attached to said frame arms, a motor and an interchangeable massage head. The motor of the device is located within the housing and can be powered by a disposable or rechargeable battery. Further, the motor attaches to a shaft that receives a massage head. The massage head may be fixedly-attached or removably-attached to the shaft in differing embodiments. In addition, the massage head may have any firm or semi-firm material and may be shaped in a plurality of massage or therapy aiding specific shapes. The heads may also have a fabric or other coverings, which may be removed for washing, as well as projections provided on the head in a number of different configurations.

The housing may include a pair of hinged-attached, foldable frame arms. Each frame arm has a hinge-attached handle which may be angled forward or backward to easily accommodate the hand of the user. Accordingly, both the frame arms and handles can both be folded for storage, handling or transport purposes. In differing embodiments, the handle or top surface of the housing may have a power button and intensity button that allows a user to control the power of the motor and intensity of the massage or therapy head. To begin using the device, an individual first unfolds the frame arms and handles and locks the hinges of the arms and handles into place. Then, the motor and massage head can be activated via the power and intensity level buttons via the buttons located on the top surface of the handle. Next, the unfolded device can be flipped one-hundred and eighty degrees or to any position so as to reach around the back or other body area of the user. As such, a user can then move his or her arms or shoulders to allow the massage or therapy device to reach and massage or treat differing areas of the back or body area.

As a result, the massaging or therapy providing device of the present invention is particularly advantageous as it allows a user to massage the back or other body part in an easier manner than while using existing massage devices. Further, the manner in which the device can be operated requires little flexibility or dexterity. In contrast, the same may not be true if a user attempted to massage the same back areas with existing massage device. Further, unlike existing massage devices, the back massaging device of the present invention can be folded into a much smaller compact shape for storage, handling and transport purposes.

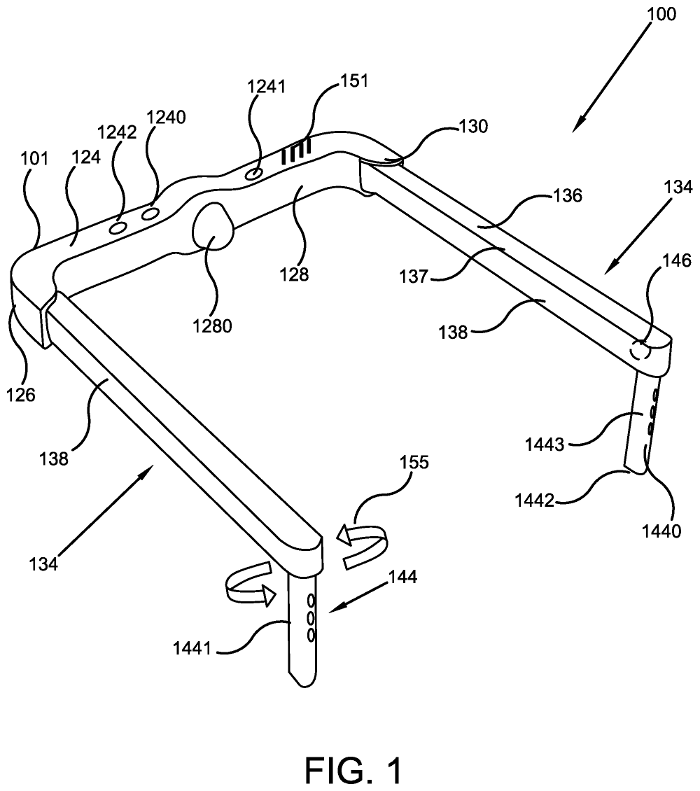

Referring initially to the drawings, FIG. 1 illustrates a perspective view of one potential embodiment of a massaging or therapy-providing device 100 of the present invention in an unfolded position. The preferred embodiment of the device 100, has a generally U-shaped housing or frame 120 that further includes a pair of hinge-attached foldable frame arms 134, and a pair of foldable handles 144 attached to the frame arms 134. The frame arms 134 are attached to a base frame member 101, on each end of the base member. A motor 122, and a massage head 1280. It is also contemplated that in a preferred embodiment of the device 100 all components of the device 100 (unless otherwise stated) are manufactured from a durable, rigid plastic that may be any derivate of plastics such as but not limited to: acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, etc. Alternatively, all or some combination of the components of the device 100 may be comprised of a durable, lightweight metal such as aluminum. In addition, the molded handles may include an anti-microbial element such that the device can be used by different individuals without spreading germs or bacteria. The anti-microbial material may be MicroBan® or similar available solutions.

The body 110 of the device 100 is generally U-shaped housing 120 that has a top surface 124, a bottom surface 126, a front surface 127 and a rear surface 128. It is contemplated that the dimensions of the housing 120 are such that the body 110 can easily fit around the shoulders, upper body and/or back 10 of an individual during use. Within the housing 120, the device 100 has a small electric motor 122 that can be accessed via a removable access plate 129 within the rear surface 128 of the frame or housing. The motor 122 may be powered via a battery such as a disposable battery or a rechargeable battery in the form of an alkaline, nickel-cadmium, nickel-metal hydride battery, etc. such as any 3V-12 volts DC battery or other conventional battery such as A, AA, AAA, etc. may supply power to the motor 122. The term “battery” or “batteries” may be used to refer to one or more wet or dry cells or batteries of cells in which chemical energy is converted into electricity and used as a source of DC power. References to recharging or replacing batteries may refer to recharging or replacing individual cells, individual batteries of cells, or a package of multiple battery cells as is appropriate for any given battery technology that may be used. Further, in an embodiment of the device 100 where the motor 122 contains a rechargeable battery, the battery may be recharged via a USB charging port 1241 on the top surface 125 of the housing 120, wherein the charging port 1241 may be comprised of a USB-A, USB-B, Micro-B, Micro-USB, Mini-USB, or USB-C port. The frame may also have a timer 152 to show the duration of the massage or treatment and the timer may include an alarm to notify the individual that sufficient time has elapsed and the treatment or massage should end or that the battery life is low.

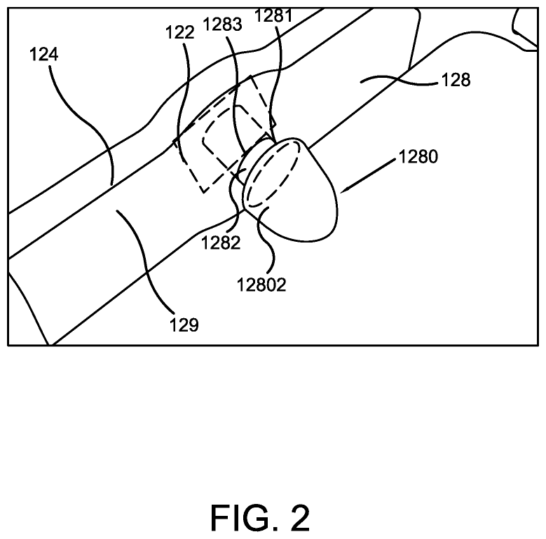

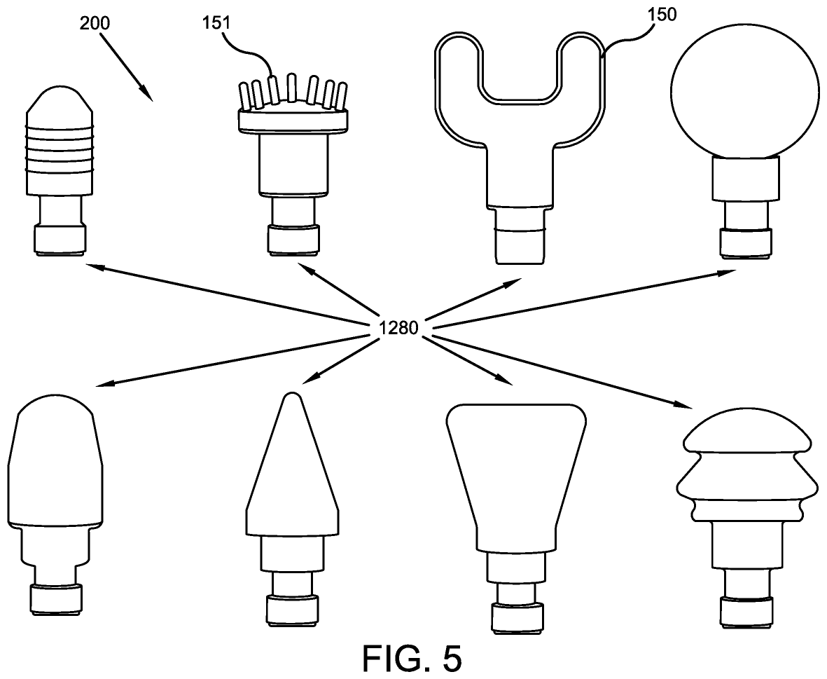

As best seen in FIG. 2, the motor 122 receives a shaft 1282 of a massage head 1280 via an opening 1283 in the rear surface 128. The motor 122 then pulsates the shaft 1282 in an inward and outward motion, such that the massage head 1280 pulsates to massage the body of the user. It is also contemplated that the massage head 1280 may be removably or fixedly-attached to the shaft 1282. The fixedly-attached version of the head 1280 is preferably molded to the shaft 1282. The removable version has a semi-continuous opening 12802 on the bottom surface 1281 of the head 1280 that allows the head 1280 to be slid over and connected to the shaft 1282. In differing embodiments of the device 100, the massage head 1280 may be made of any firm or semi-firm material such as rubber or foam and may be shaped like a plurality of differing shapes as shown in FIG. 5. Accordingly, each differing shape of each massage head 1280 may be optimized for certain areas of the body or back 10 (or even certain areas of other body parts that the device 100 could be used on). In addition, the device 100 may have a kit 200 of removable massage heads 1280 of differing shapes.

Accordingly, the powering of the motor 122 may be controlled via a power button 1240. Further, the intensity of the pulsation of the massage head 1280 can be controlled via an intensity level button 1242 that raises or lowers the intensity of the pulsating, depending on the direction the button 1242 is pressed. Both buttons 1240, 1242 may be located on various surfaces throughout the body 110, including (but not limited to) the top surface 124 of the housing 120 or the front surface 1440 of the handles 144 (as will be explained more fully below).

As also seen in FIG. 1, the housing 120 has a pair of foldable frame arms 134 which are preferably connected to the housing 120 through an opening 130 on each side of the housing 120 and via at least one hinge 132 within the opening 130. In differing embodiments, the at least one hinge 132 may be a plurality of hinge types such as but not limited to: an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc. Accordingly, the at least one hinge 132 allows the arms 134 to fold for storage or transport purposes (as will be discussed more fully below) but also extend and lock such that the arms 134 can remain in a usable position for back massaging. Each arm 134 is further preferably rectangular or cylindrical in shape with rounded edges 137 such that the junction between the top surface 136, side surfaces 138, and bottom surface 140 of the arms 134 do not uncomfortably dig into the body of a user during use.

Each arm 134 includes a foldable handle 144. Each handle 144 is preferably rectangular or cylindrical in shape with rounded edges 1443 such that the junction between the front surface 1440, side surfaces 1441, and bottom surface 1442 of the handle 144 does not uncomfortably dig into the hand 12 of an individual during use. As also noted above, the front surface 1440 of each handle 144 may have the power button 1240 or intensity level button 1242 that allows a user to control the motor 122 and massage head 1280. Alternatively, the side surfaces 1441 or bottom surface 1442 may have the power button 1240 or intensity level button 1242 that allow a user to control the motor 122 and massage head 1280. Further, each handle 144 is preferably attached to each frame arm 134 via at least one hinge 146. The handles 144 and 1440 are movable as shown by 155 and can be adjusted by the individual to have a more comfortable fit. In differing embodiments, the at least one hinge 146 may be a plurality of hinge types such but not limited to: an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc.

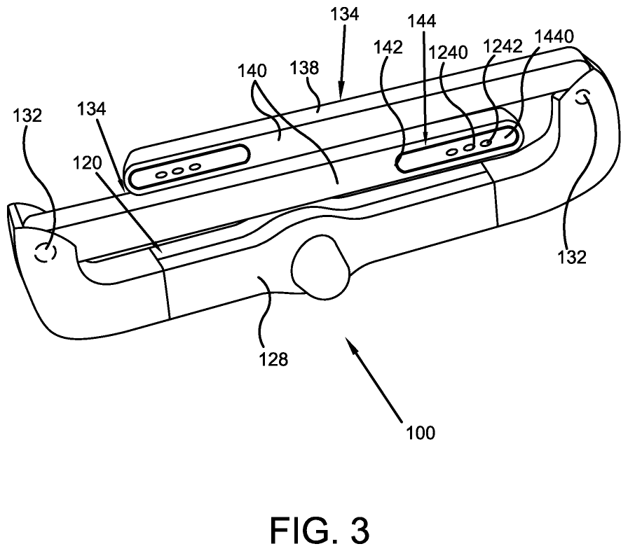

FIG. 3 illustrates a perspective view of one potential embodiment of a massaging or therapy device 100 of the present invention in a folded position. As noted, the device 100 can be folded for storage, handling or transport when not in use. In the folded position, both arms 134 fold ninety-degrees downward such that they are parallel with the rear surface 128 of the housing 120. Further, each handle 144 may fold ninety degrees upwards to be stored within a compartment 142 located in the bottom surface 140 of each arm 134 such that the handles 144 are concealed from view and cannot snag on objects or unintentionally activate the motor 122 during transport or storage. In this manner, the device 100 can become more compact for easy transport, handling and/or storage.

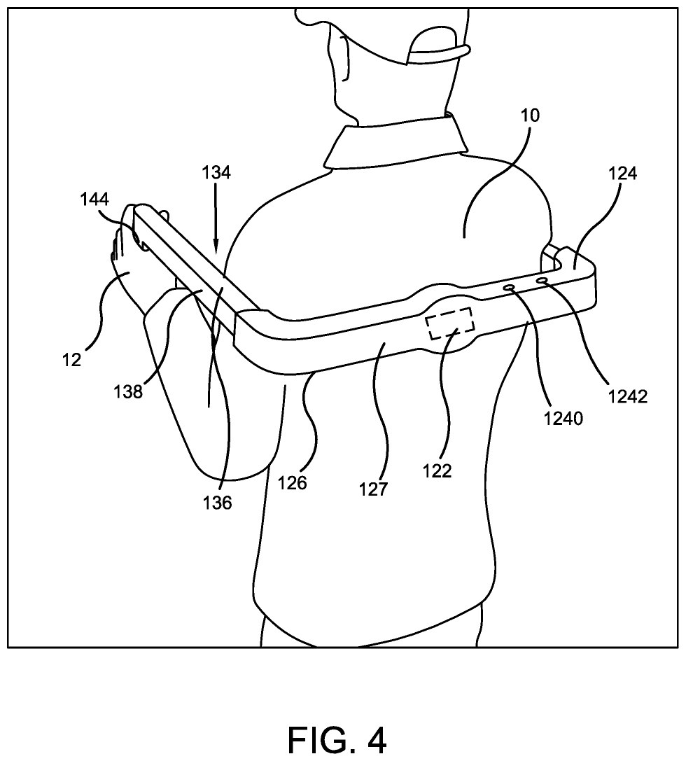

FIG. 4 illustrates a perspective view of one potential embodiment of the back massaging device 100 of the present invention in an unfolded position and being used by a user to massage their back 10. To use the device 100 to massage a body portion or back 10 area, a user first unfolds the frame arms 134 and the handles 144 which then remain in a locked position. Then, the device 100 can be gripped by the handles 144 and flipped one-hundred and eight degrees around the body portion or back 10 of the user. A user can then power on the device 100 via the power button 1240 and set the massage intensity via the intensity level button 1242 on a handle 144 of the device 100. In an embodiment of the device 100 the top surface 124 of the housing 124 has both buttons 1240, 1242 a user can simply set both buttons 1240, 1242 to their desired setting before positioning the device 100 to their body area or back 10. Accordingly, once in position around the body of an individual, the user can open the handles 144 and the movement of their arms or shoulders to move the massage head 1280 to differing areas of their back 10 for massaging.

FIG. 5 provides a view of a plurality of different massage or treatment heads 1280. The heads may be provided with a covering 150 which may be fabric or other material which can cover the head and can be washed or discarded. Extensions or projections 151 may also be present on the heads of the device so as to provide extra stimulation or treatment as part of the use of the massage device.

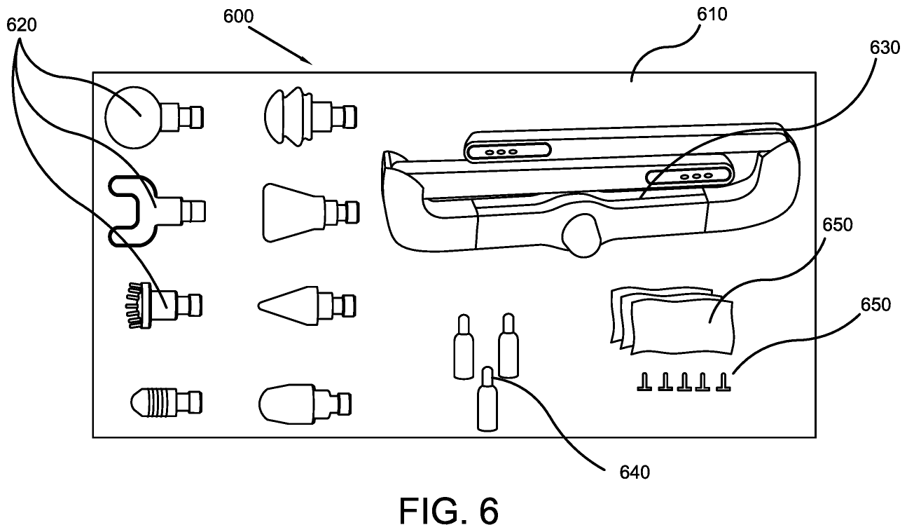

FIG. 6 shows a kit for the sale and distribution of the massaging or therapy device. The kit 600 comes in a suitable container 610 for retail display or for shipping. Provided in the container 610 are a series of different massage or therapy heads 620, the massaging device 630 in a folded condition and a container of massage oil 640, which may be essential oils to aid in the massaging or treatment of the body. The kit may also include covers 650 for the massage heads and which are either washable or disposable and removable projections 660 for adding additional tactile elements to the massage heads.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “back massaging device” and “device” are interchangeable and refer to the back massaging device 100 of the present invention.

Notwithstanding the forgoing, the back massaging device 100 of the present invention and its various components can be of any suitable size and configuration as is known in the art without affecting the overall concept of the invention, provided that they accomplish the above-stated objectives. One of ordinary skill in the art will appreciate that the size, configuration and material of the back massaging device 100 as shown in the FIGS. are for illustrative purposes only, and that many other sizes and shapes of the back massaging device 100 are well within the scope of the present disclosure. Although the dimensions of the back massaging device 100 are important design parameters for user convenience, the back massaging device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A massage device comprising:
a frame having a base member and a pair of frame arms, wherein each of the pair of frame arms is attached to an opposite end of the base member;
a motor provided on the frame;
a massage head attached to the frame and connected to the motor; and
a handle attached to each of the pair of frame arms.

2. The massage device as recited in claim 1, wherein each of the handles is repositionable to be concealed within the pair of frame arms.

3. The massage device as recited in claim 2, wherein each of the handles is rotatable relative to the pair of frame arms.

4. The massage device as recited in claim 1, wherein the massage head is removably attached to the frame.

5. The massage device as recited in claim 1, wherein each of the pair of frame arms is hingedly attached to the base member.

6. The massage device as recited in claim 1, wherein the motor comprises a shaft that is attached to the massage head.

7. The massage device as recited in claim 6, wherein the massage head is removable from the shaft.

8. The massage device as recited in claim 7, wherein the base member comprises a plurality of controls to operate the motor.

9. The massage device as recited in claim 8, wherein the plurality of controls comprises a power button and an intensity button.

10. The massage device as recited in claim 8, wherein the base member further comprises a battery and a timer for determining a duration of a massage or a battery usage.

11. A foldable massaging tool comprising:
a frame having a pair of arms hingedly connected to a base member, wherein the pair of arms each have a handle disposed near an end of each of the pair of arms, and further wherein the pair of arms are rotatable relative to the base member;
a motor disposed within the frame and having a shaft extending out of the frame;
a massage head connected to the shaft and movable by the motor, wherein the massage head is removable from the shaft; and
a plurality of controls provided on the frame for operating the motor and the massage head.

12. The foldable massaging tool as recited in claim 11, wherein the plurality of controls comprises a power button and an intensity control button.

13. The foldable massaging tool as recited in claim 11, wherein the frame further comprises a battery and a USB port for charging the battery.

14. The foldable massaging tool as recited in claim 11, wherein the massage head further comprises at least one of a covering or a projection.

15. The foldable massaging tool as recited in claim 11, wherein the massage head is comprised of a rubber or a foam material.

16. The foldable massaging tool as recited in claim 11, wherein the handles are rotatable and foldable so as to be concealed within each of the pair of arms.

17. The foldable massaging tool as recited in claim 13, wherein the base member further comprises a timer for determining a duration of a massage or of the usage of the battery.

18. A massage tool kit comprising:
a package;
a plurality of massage heads, wherein each of the plurality of massage heads comprise a different configuration;
a frame comprises of a base member and a pair of arms, wherein each of the pair of arms comprises a handle; and
a motor having a shaft, wherein the shaft is capable of interchangeable connecting with each of the plurality of massage heads and the pair of arms are foldable outwardly from the base member.

19. The massage tool kit as recited in claim 18 further comprising at least one of a cover and a removable protrusion for attachment to the plurality of massage heads.

20. The massage tool kit as recited in claim 18 further comprising a massage oil.
